(19) United States
(12) Patent Application Publication
(10) Pub. No.: US 2004/0052028 A1
(43) Pub. Date: Mar. 18, 2004

(54) Atmospheric pressure plasma assembly

(76) Inventors: Fergal O'Reilly, Dublin (IE); Peter Dobbyn, Cork (IE); Anthony Herbert, Cork (IE)

Correspondence Address: MCKELLAR STEVENS & HILL PLLC, POSEYVILLE PROFESSIONAL COMPLEX, 784 SOUTH POSEYVILLE ROAD, MIDLAND, MI, 48640, US

(21) Appl. No.: 10/415,382

(22) PCT Filed: Oct. 26, 2001
(86) PCT No.: PCT/IE01/00138

(30) Foreign Application Priority Data
Oct. 26, 2000 (IE) 2000/0867

(51) Int. Cl. H02H 9/06

(52) U.S. Cl. 361/120

(57) ABSTRACT

An atmospheric plasma assembly has a pair of parallel spaced apart planar electrodes each bonded to a dielectric plate. Two spacer plates separate the dielectric plates to form a plasma region. Sparge poles having nozzles are used to spray cooling water on the dielectric plates and electrodes. Ideally the dielectric plates and electrodes are vertically arranged.

The present invention relates to an atmospheric pressure plasma assembly of the type comprising a pair of parallel spaced apart planar electrodes with at least one dielectric plate therebetween and adjacent one electrode, the spacing between the dielectric plate and the other dielectric plate or electrodes forming a plasma region for a precursor gas.

When matter is continually supplied with energy, its temperature increases and it typically transforms from a solid to a liquid and, then, to a gaseous state. Continuing to supply energy causes the system to undergo yet a further change of state in which neutral atoms or molecules of the gas are broken up by energetic collisions to produce negatively charged electrons, positive or negatively charged ions and other species. This mix of charged particles exhibiting collective behavior is called “plasma”, the fourth state of matter. Due to their electrical charge, plasmas are highly influenced by external electromagnetic fields that make them readily controllable. Furthermore, their high energy content allows them to achieve processes which are impossible or difficult through the other states of matter, such as by liquid or gas processing.

The term “plasma” covers a huge range of systems whose density and temperature vary by many orders of magnitude. Some plasma is very hot and all the microscopic species (ions, electrons, etc.) are in approximate thermal equilibrium, the energy input into the system being widely distributed through atomic/molecular level collisions. Other plasmas, however, particular those at low pressure (e.g. 100 Pa) where collisions are relatively infrequent, have their constituent species at widely different temperatures and are called “non-thermal equilibrium” plasmas. In these non-thermal plasmas the free electrons are very hot with temperatures of many thousands K whilst the neutral and ionic species remain cool. Because the free electronics have almost negligible mass, the total system heat content is low and the plasma.” operates close to room temperature thus allowing the processing of temperature sensitive materials, such as plastics or polymers, without imposing a damaging thermal burden onto the sample. However, the hot electrons create, through high energy collisions, a rich source of radicals and excited species with a high chemical potential energy capable of profound chemical and physical reactivity. It is this combination of low temperature operation plus high reactivity that makes non-thermal plasmas technologically important and a very powerful tool for manufacturing and material processing, capable of achieving processes which, if achievable at all without plasma, would require very high temperatures or noxious sand aggressive chemicals.

For industrial applications of plasma technology, a convenient method is to couple electromagnetic power into a volume of process gas that can be mixtures of gases and vapors in which the workpieces/samples to be treated are immersed or passed through.

The gas becomes ionized into plasma generating the chemical radicals, Ultra Violet radiation, and ions that react with the surface of the samples. By correct selection of process gas composition, driving power frequency, power coupling mode, pressure and other control parameters, the plasma process can be tailored to the specific application required by the manufacturer.

Because of the huge chemical and thermal range of plasmas, they are suitable for many technological applications that are being continually extended. Non-thermal equilibrium plasmas are particularly effective for surface activation, surface cleaning, material etching and coating of surfaces.

The surface activation of polymeric materials is a widely used industrial plasma technology pioneered by the automotive industry. Thus, for example, the polyolefin, such as polyethylene and polypropylene, which are favored for their recylability, have a non-polar surface and consequent poor disposition to coating or gluing. However, treatment by oxygen plasma results in the formation of surface polar groups giving high wettability and consequent excellent coverage and adhesion of metal pant, adhesive or other coating. Thus, for example, plasma surface engineering is essential to the manufacture of vehicle fascias, dashboards, bumpers etc. and to component assembly in the toy, etc. industries. Many other applications are available in the printing, painting, gluing, laminating and general coating of components of all geometries in polymer, plastic, ceramic/inorganic, metal and other materials.

The increasing pervasiveness and strength of environmental legislation world-wide is creating substantial pressure on industry to reduce or eliminate the use of solvents and other wet chemicals in manufacturing, particularly for component/surface cleaning. In particular, CFC-based degreasing operations have been largely replaced by plasma cleaning technology operating with oxygen, air and other non-toxic gases. Combining water based pre-cleaning with plasma allows evenly heavily soiled components to be cleaned and surface qualities obtained are typically superior to those resulting from traditional methods. Any organic surface contamination is rapidly scavenged by room temperature plasma and converted to gaseous CO2 and water that can be safely exhausted.

Plasmas can also carry out etching of a bulk material, i.e. removal of unwanted material. Thus, for example, an oxygen-based plasma will etch polymers, a process used in the production of circuit boards, etc. Different materials such as metals, ceramics and inorganics are etched by careful selection of precursor gas and attention to the plasma chemistry. Structures down to nanometer critical dimension are now being produced by plasma etching technology.

A plasma technology that is rapidly emerging into mainstream industry is that of plasma coating/thin film deposition. Typically, a high level of polymerization is achieved by application of plasma to monomeric gases and vapors. Thus, a dense, tightly knit and three-dimensionally connected film can be formed which is thermally stable, chemically very resistant and mechanically robust. Such films are deposited conformally on even the most intricate of surfaces and at a temperature that ensures a low thermal burden on the substrate. Plasmas are therefore ideal for the coating of delicate and heat sensitive, as well as robust materials. Plasma coatings are free of micro pores even with thin layers. The optical properties, e.g. color, of the coating can often be customized and plasma coatings adhere well to even non-polar materials, e.g. polyethylene, as well as steel (e.g. anti-corrosion films on metal reflectors), ceramics, semiconductors, textiles, etc.

In all these processes, plasma engineering produces a surface effect customized to the desired application or product without affecting the material bulk in any way.

Plasma processing thus offers the manufacturer a versatile and powerful tool allowing choice of a material for its bulk technical and commercial properties while giving the freedom to independently engineer its surface to meet a totally different set of needs. Plasma technology thus confers greatly enhanced product functionality, performance, lifetime and quality and gives the manufacturing company significant added value to its production capability.

These properties provide a strong motivation for industry to adopt plasma-based processing, and this move has been led since the 1960s by the microelectronics community which has developed the low pressure Glow Discharge plasma into an ultra-high technology and high capital cost engineering tool for semiconductor, metal and dielectric processing. The same low pressure Glow Discharge type plasma has increasingly penetrated other industrial sectors since the 1980s offering, at more moderate cost, processes such as polymer surface activation for increased adhesion/bond strength, high quality degreasing/cleaning and the deposition of high performance coatings. Thus, there has been a substantial take-up of plasma technology.

However, adoption of plasma technology has been limited by a major constraint on most industrial plasma systems, namely, their need to operate at low pressure. Partial vacuum operation means a closed perimeter, sealed reactor system providing only off-line, batch processing of discrete workpieces. Throughput is low or moderate and the need for vacuum adds capital and running costs.

Atmospheric pressure plasmas, however, offer industry open port or perimeter systems providing free ingress into and exit from the plasma region by workpieces/webs and, hence, on-line, continuous processing of large or small area webs or conveyor-carried discrete workpieces. Throughput is high, reinforced by the high species flux obtained from high pressure operation. Many industrial sectors, such as textiles, packaging, paper, medical, automotive, aerospace, etc., rely almost entirely upon continuous, on-line processing so that open port/perimeter configuration plasmas at atmospheric pressure offer a new industrial processing capability.

Corona and flame (also a plasma) treatment systems have provided industry with a limited form of atmospheric pressure plasma processing capability for about 30 years. However, despite their high manufacturability, these systems have failed to penetrate the market or be taken up by industry to anything like the same extent as the lower pressure, bath-processing-only plasma type. The reason is that corona/flame systems have significant limitations. They operate in ambient air offering a single surface activation process and have a negligible effect on many materials and a weak effect on most. The treatment is often non-uniform and the corona process is incompatible with thick webs or 3D workpieces while the flame process is incompatible with heat sensitive substrates. It has become clear that atmospheric pressure plasma technology must move much deeper into the atmospheric pressure plasma spectrum to develop advanced systems meeting industry needs.

Several of the most serious process deficiencies of current non-equilibrium atmospheric pressure plasma manufacturing technology, i.e. Corona treatment, arise from the geometry of the equipment used to generate the Corona plasma type and the resulting relatively small volume of plasma generated. The Corona plasma type is generated by applying a high voltage between two generally asymmetric opposing electrodes separated by a gap containing the precursor process gas from which the plasma is formed. The key to Corona generation is the presence of point, linear or other singularities in the electric field distribution between the electrodes creating very high local electric potential gradients at the singularity leading to localized breakdown of the precursor gas and plasma formation. Such singularities are achieved by sharply localized electrode geometries such as point versus plane, point versus point, wire/rod versus plane, wire/rod versus wire/rod, and, the typical industrial Corona treatment equipment configuration, wire/rod versus parallel roller. The plasma takes the form of an array of discrete plasma streamers generally following the electric field lines of force between the electrodes in the region of highest electric potential gradient.

The volume of plasma generated is governed by the electric field distribution. If the electric field is non-uniform, then, by definition, as the electric field strength increases, part only of the field region will approach and achieve the precursor gas break down voltage gradient necessary to strike a plasma. The remainder of the field region will be below the breakdown threshold so that no plasma will be generated. The volume of plasma generated is, thus, restricted by the extent of electric field non-uniformity.

In the case of conventional Corona treatment, the electric potential gradient, i.e. the electric field, is very high close to the electrode creating the electric field singularity but drops off rapidly (inverse square or higher power) with distance from such electrode, e.g. point or wire/rod. Formation of plasma is, therefore, limited to the region of voltage gradient that reaches the point at which the precursor gas breaks down and transforms into plasma. The regions of electric field below gas breakdown cannot generate and sustain plasma. Attempting to increase the volume of plasma by raising voltage gradients cannot change the electric field distribution and, thus, the plasma distribution and volume will be broadly unaffected, additional power appearing as current in the plasma streamers.

The electrode geometry and mode of plasma generation in conventional Corona treatment thus results in a fundamental limitation in the volume of plasma that can be generated by a single set of electrodes. If the industrial process involves the treatment of extensive workpieces, such as moving webs or articles on a conveyor, although there is, in principle, no limit to the extent of plasma generation in the x- or workpiece/plasma width direction, the extent of Corona plasma in the y- or workpiece/plasma length direction is highly limited, typically a few tens of millimeters in industrial Corona systems. This limitation has the following disadvantages:

1. The residence time(s) in the plasma of the workpiece moving at constant line throughput speed (m/s) is relatively short an can only be increased by reducing line speed. Residence time in the plasma affects the degree of surface activation or cleaning and the thickness of any plasma deposited coating.

2. The energy per unit area (J/m2) coupled by the plasma into the workpiece is relatively low and can only be increased by reducing line speed and/or increasing plasma power density ON/m2). Energy coupled in affects all activation, cleaning or coating processes.

3. Brief exposure of the workpiece to the discrete streamers of the Corona does not allow the plasma to access all the surface area and, thus, given non-uniform treatment leading to poor product performance.

These disadvantages motivate a system for the generation of cool, non-thermal equilibrium, atmospheric pressure plasmas over an extended area, in particular extended in the workpiece/plasma length direction. Thus, instead of a Corona plasma area of, say, 10 m wide×0.02 m long, the new system should be capable of a plasma area of 10 m wide×20 m long, at least a three orders of magnitude increase in plasma path length. The advantages area shown by the following:

Let: 1=plasma path length (m)

t=residence time of any workpiece element in plasma(s).

v=line throughput speed (m/s)

P=plasma power density W/m2)

E=energy/unit area coupled into workpiece (J/m2)

Then: t=/v

so that, at fixed v, t α I

And: E=Pt=P/v

so that, at fixed v and P, E α I

Thus, for example, if I is increased from 0.02 m to 20 m, both E and t are increased by 10³. Alternatively, if E and t are kept constant, line speed v can be increased by 10³ to achieve the same treatment.

Significant advances have been made in plasma deposition at atmospheric pressure. Considerable work has been done on the stabilization of atmospheric pressure glow discharges, described in Appearance of stable glow discharge in air, argon, oxygen and nitrogen at atmospheric pressure using a 50 Hz source by Satiko Okazaki, Masuhiro Kogoma, Makoto Uehara and Yoshihisa Kimura, J. Phys. D: Appl. Phys. 26 (1993) 889-892. Further, there is described in U.S. Pat. Specification No. 5,414,324 (Roth et al) the generation of a steady-state glow discharge plasma at atmospheric pressure between a pair of insulated metal plate electrodes spaced up to 5 cm apart and R.F. energized with an rms potential of 1 to 5 kV at 1 to 100 kHz. This patent specification describes the use of electrically insulated metallic plate electrodes. This patent specification describes the problems of electrode plates and the need to discourage electrical breakdown at the edge of electrodes. It further describes the use of the electrodes that in this case are copper plates and a water cooling system which is supplied through fluid flow conduits bonded to the electrodes, and as such water does not come into direct contact with any electrode surface.

In U.S. Pat. Specification No. 5,185,132, (Horiike et al), there is described an atmospheric plasma reaction method in which plate electrodes are used in a vertical configuration. However, they are merely used in the vertical configuration to prepare the plasma and then the plasma is directed out from between the plates onto a horizontal surface below the vertically arranged electrodes.

### THE INVENTION

According to the invention there is provided an atmospheric pressure plasma assembly of the type comprising a pair of parallel spaced-apart planar electrodes with at least one dielectric plate there between and adjacent one electrode, the spacing between the dielectric plate and the other dielectric plate or electrode forming a plasma region for a precursor gas characterized in that when an electrode is adjacent a dielectric plate, a cooling liquid distribution system is provided for directing a cooling conductive liquid onto the exterior of the electrode to cover a planar face of the electrode. This overcomes one of the major problems of such atmospheric pressure plasma assemblies ensuring an extended area particularly in the workpiece/plasma length direction. Further, the rest time of the plasma or workpiece moving at a constant speed can be regularly increased enhancing the target process whether it be activation cleaning or coating. It has all of the advantages attendant on longer resident time in the plasma region.

Ideally the cooling liquid covers the face of the electrode remote from the dielectric plate. The cooling conductive liquid is water and may contain conductivity controlling compounds such as metal salts or soluble organic additives. Ideally the electrode is a metal electrode in contact with the dielectric plate. In one embodiment there are a pair of metal electrodes each in contact with a dielectric plate. The water in accordance with the present invention acts as well as being an extremely efficient cooling agent to also assist in providing an efficient electrode.

Ideally the dielectric plate extends beyond the perimeter of the electrode and the cooling liquid is also directed across the dielectric plate to cover at least that portion of dielectric bordering the periphery of the electrode. Preferably all the dielectric plate is covered with cooling liquid. The electrode may be in the form of a metal mesh. The electrodes may be arranged substantially vertically. Ideally insulated spaces are mounted between the electrodes. Surprisingly, in addition to cooling the water it also acts to electrically passivate any boundaries, singularities or non-uniformity in the metal electrodes such as edges, corners or mesh ends where the wire mesh electrodes are used; Effectively the water acts as an electrode of limited conductivity.

Further, by having a vertical arrangement, the weight of large areas of electric systems are now placed so that there is not the same sag or distortion or deformation that there would otherwise be.

In one embodiment of the invention the electrode forms part of an electrode assembly comprising a watertight box having a side formed by a dielectric plate having bonded thereto on the interior of the box the planar electrode a liquid inlet and a liquid outlet. Two of these made together form an assembly. This box like arrangement allows modularity and is a particularly efficient way of providing the electrode assembly.

In another embodiment of the invention the electrode forms part of an electrode assembly comprising: a watertight box having two parallel sides each formed from a dielectric plate end each having bonded thereto on the interior of the box one of a pair of planar electrodes; a liquid inlet; and a liquid outlet.

With this latter embodiment this box may be used” in conjunction with other boxes according to the invention. Ideally the boxes are one on top of the other to provide an extended plasma region. This allows considerable flexibility and can allow an arrangement such that there can be very long plasma path length with very small factory footprints.

In one embodiment of the invention the liquid distribution system comprises a cooler and a recirculation pump.

In another embodiment the cooling liquid distribution system comprises a sparge pipe incorporating spray nozzles. Further, the invention provides a method of treating a substrate using an assembly and it would be appreciated that the invention therefore provides a substrate manufactured in accordance with the assembly or the method of the invention.

### BRIEF DESCRIPTION OF THE DRAWINGS

The invention will be more clearly understood from the following description of some embodiments thereof given by way of example only with reference to the accompanying drawings, in which:

FIG. 1 is a front view of an atmospheric pressure plasma system according to the invention.

FIG. 2 is a partially exploded perspective view of portion of the system illustrated in FIG. 1.

FIG. 3 is an exploded perspective view of a plasma assembly forming part of the system.

FIG. 4 is a typical vertical sectional view through the plasma assembly.

FIG. 5 is exploded view of another construction of plasma assembly.

FIG. 6 is an exploded view similar to FIG. 3 of portion of the plasma assembly of FIG. 5.

FIG. 7 is a sectional view similar to FIG. 4 of the plasma assembly of FIG. 5.

FIGS. 8, 9 and 10 are diagrammatic elevations of various arrangements of plasma assemblies forming part of an atmospheric plasma system according to the invention.

### DETAILED DESCRIPTION OF THE DRAWINGS

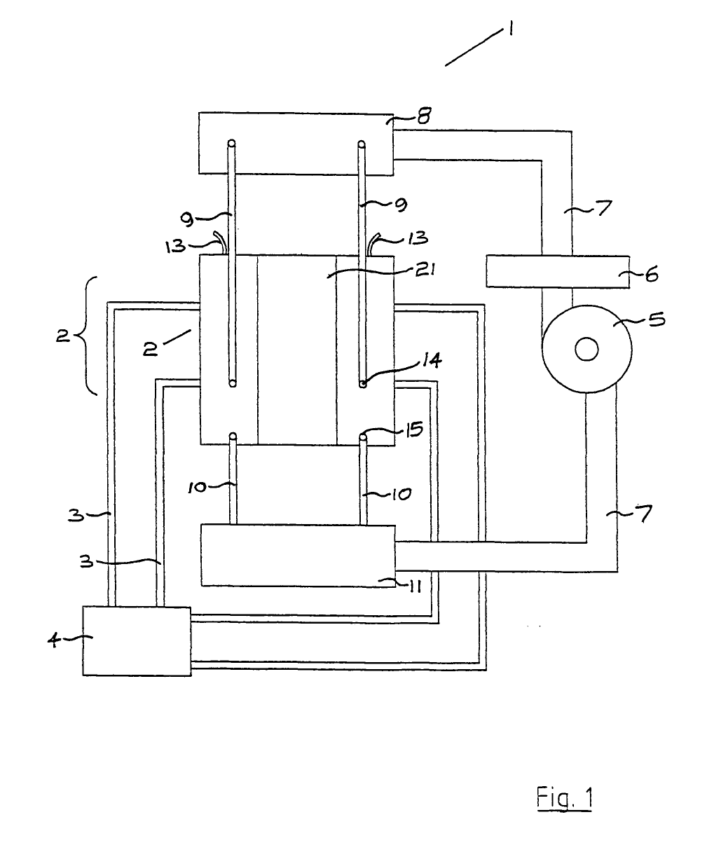

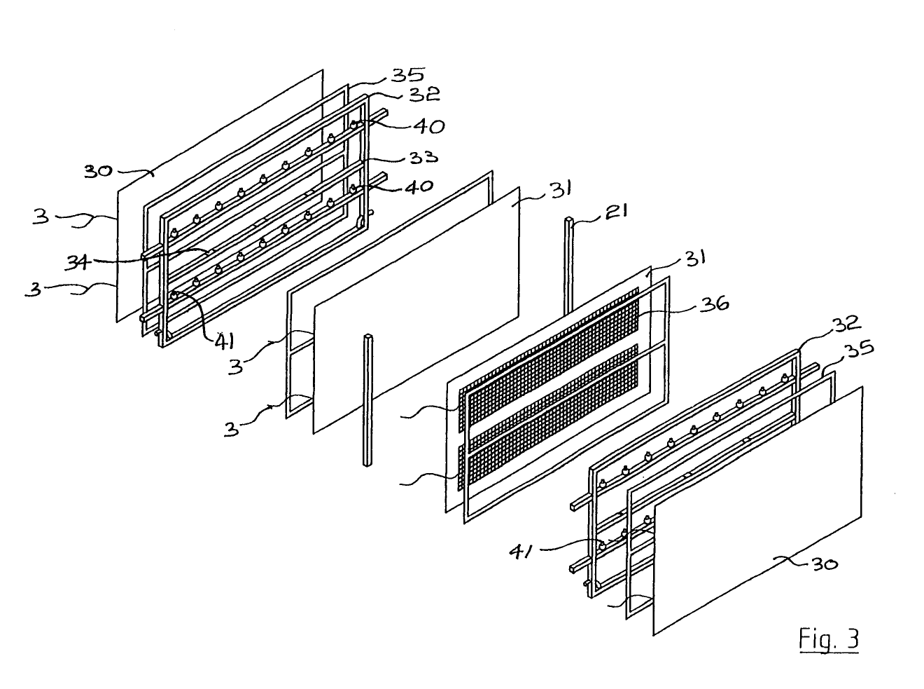

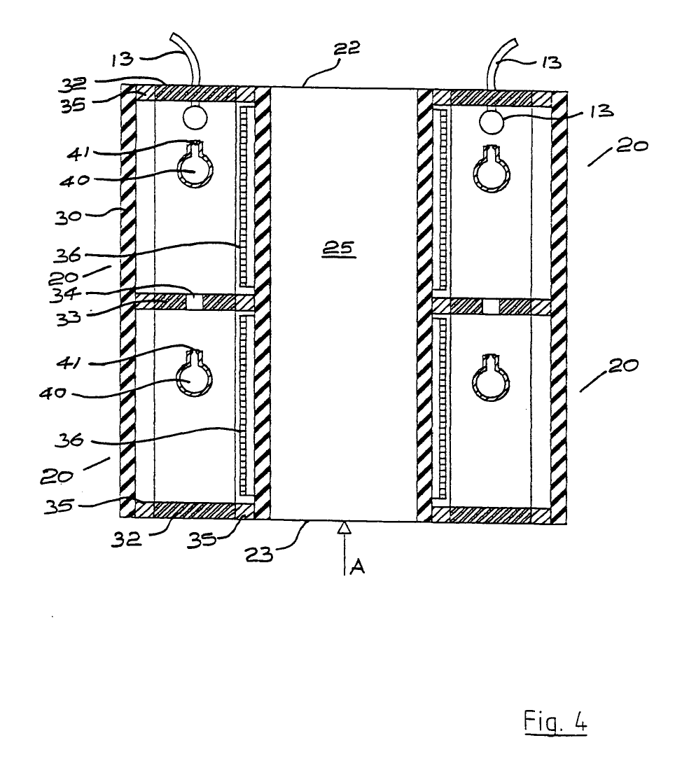

Referring to the drawings and FIGS. 1 to 4 thereof, there is provided an atmospheric plasma system, indicated generally by the reference numeral, 1 comprising, an atmospheric pressure plasma assembly 2 fed by cables 3 by a power source 4 and also fed by a cooling water assembly feeding a cooling liquid distribution system mounted within the plasma assembly 2 and described in more detail later. The cooling water assembly comprises a water pump 5, a cooler in the form of a heat exchanger 6 and main water distribution pipes 7. One of the main water distribution pipes 7 feeds an inlet manifold 8 that in turn feeds, through feed water hoses 9 and liquid inlets 14, the plasma assembly 2. Return water hoses 10 connect through liquid outlets 15, to a further return output manifold 11 that in turn is connected to another of the water distribution pipes 7 which feeds the pump 5. Pressure release pipes 13 are mounted in the plasma assembly 2.

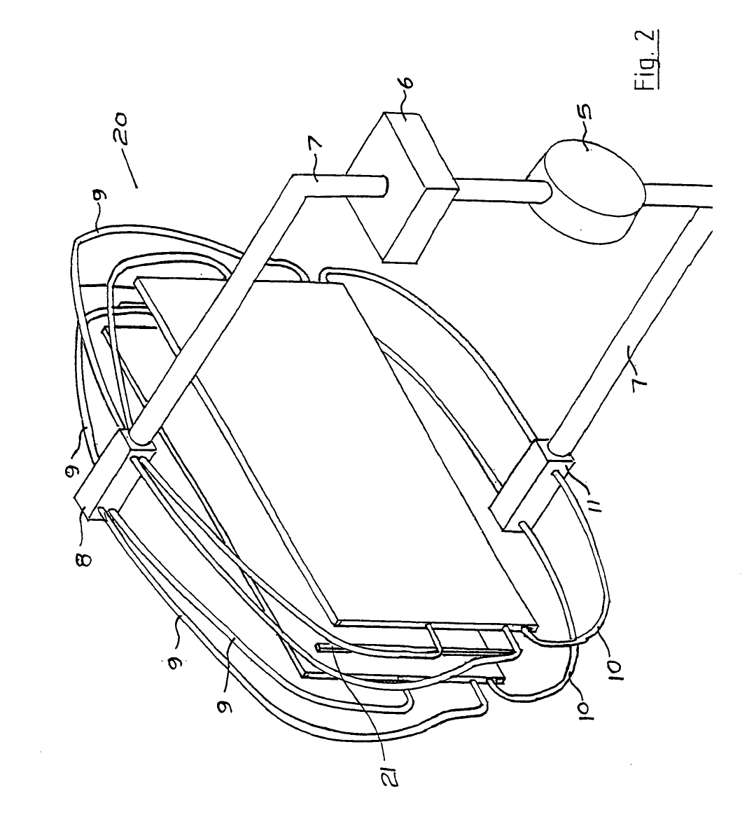

Referring in particular to FIGS. 2 to 4, the plasma assembly 2 comprises a pair of watertight boxes indicated generally by the reference numeral 20 joined by vertical insulated spacers in the form of spacer plates 21 which form between the watertight boxes 20 an open top 22 and an open bottom 23. Between the watertight boxes 20 and the spacer plates 21, there is defined a plasma region 25.

Each watertight box 20 comprises a rear plate 30 and a spaced apart front plate 31 mounted on a water containment frame 32 having a crossbar 33 in which are provided drain-off holes 34. The rear plate 30 and the front plate 31 are connected to the water containment frame 32 by gaskets 35. Two sets of wire electrodes 36 are mounted in the box 20 on the front plate 31. The rear plate 30, front plate 31 and water containment frame 32 are manufactured of a suitable dielectric material. A pair of sparge poles 40 formed from pipes of an insulation material, such as a plastics material, carrying a plurality of nozzles 41 are mounted within the box 20 and are connected to the feed water hoses 9.

In operation, a workpiece can be led through the plasma region in the direction of the arrow A but obviously it can be led down in the opposite direction and can al so be led back and forth within the plasma region 25. Process gas can be injected into the plasma region 25 and suitable power can be provided to the electrodes 36 in the plasma region 25. Water is delivered from the inlet manifold 8 through the feed water hoses 9 into the sparge poles 40 where the water is delivered in a spray out the nozzles 41 onto the wire electrodes 36 and also across the exposed interior face of the front plate 31.

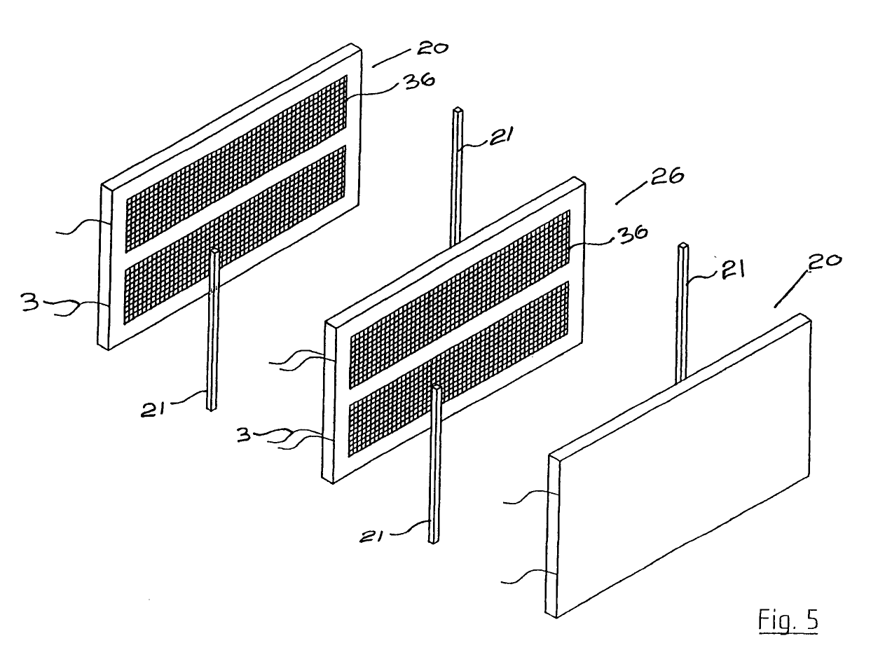

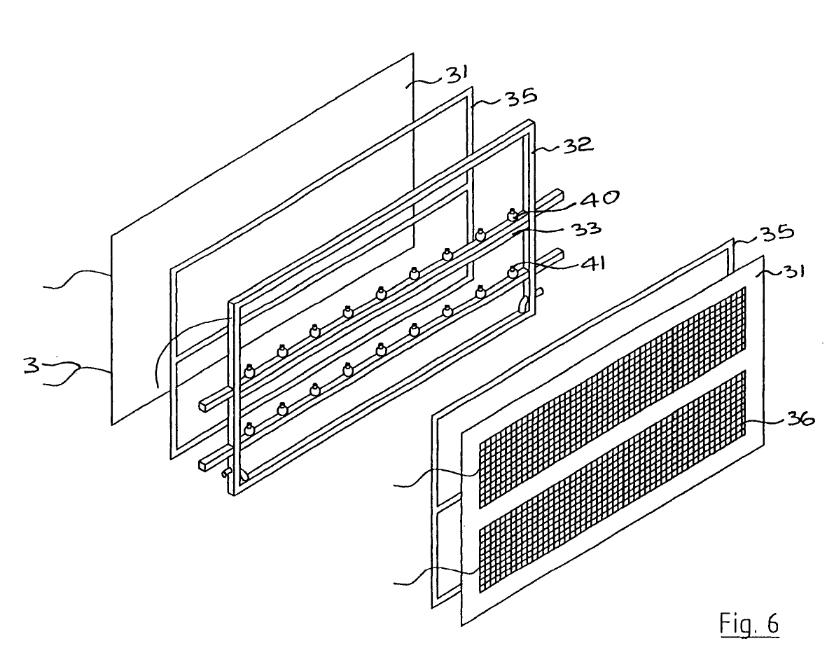

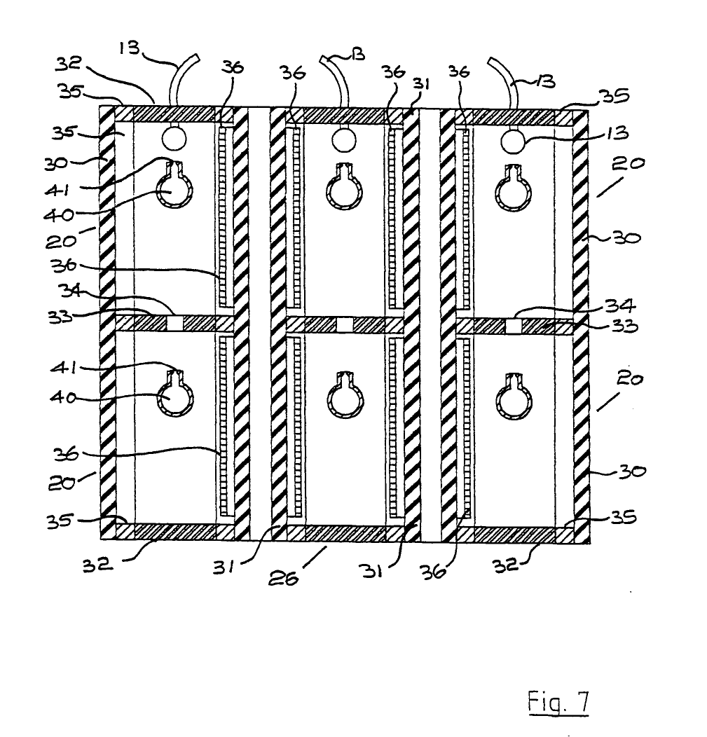

Referring to FIGS. 5 to 7 inclusive, there is illustrated an alternative construction of plasma assembly, in this case comprising two boxes identical to the boxes 20 heretofore described and a third box 26 of substantially the same construction as the boxes 20, in which parts similar to those described with reference to the previous embodiment, are identified by the same reference numerals. The only difference between the box 26 and the box 20 is that it carries effectively two front plates 31 and carries electrodes 36 on each front plate 31 since the plates 31 act as front plates in respect of the boxes 20 on either side of the box 26. In this embodiment, the nozzles 41 of the sparge poles 40 direct water onto both plates 31.

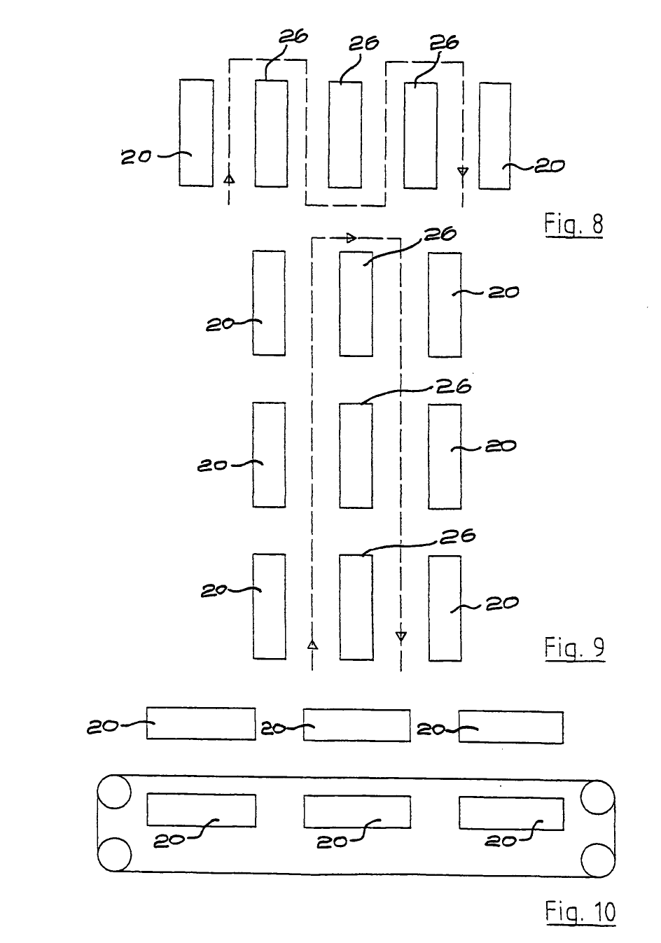

FIG. 8 shows one arrangement of three boxes 26 sandwiched between two outer boxes 20 with the web path therebetween shown by interrupted lines. FIG. 9 shows an arrangement with the various boxes stacked one on top of the other while FIG. 10 shows an arrangement with a conveyor for carrying articles between boxes 20 that are now arranged horizontally.

While in the embodiments described, the electrode has been mounted on the exterior of a dielectric plate, it is envisaged that in certain circumstances, it may alternatively be encapsulated within the dielectric plate.

Essentially, the present invention relies upon moving away from non-uniform electric fields as a mechanism of plasma generation to uniform electric fields.

With the present invention, the volume of plasma generated is governed by the electric field distribution as the electric field is uniform and then by definition as the electric field strength increases, the whole of field region will broadly approach and achieve the precursor breakdown voltage gradient necessary to strike plasma.

Ideally, no part of the field region will be below the breakdown threshold so that the plasma will be generated throughout the field. The volume of plasma generated is thus only restricted by the physical extent of the electrodes.

The present invention overcomes the problem of parallel plate electrode geometry in combination with the need for dielectric material.

The present invention overcomes the problem of thermal management. Typical inter-electrode spacing for parallel plate systems is of the order of 10 mm. Target areas can extend to 20 m×20 m or even greater areas and target plasma power densities may be of the order of 10 kW/m3 or greater. Thus, the power generated in such systems will generate heat that will be well beyond the ability of the system to dissipate without some form of forced cooling. The poor thermal conductivity of most dielectric materials in direct contact with the plasma and the relatively long thermal paths involved in the geometry in turn exacerbate this. The present invention overcomes this problem. Water is the preferred but not the only cooling liquid that could be used.

In one embodiment of the invention, the water contains conductivity controlling compounds such as metal salts, including metal halides, sulphates, carbonates, organic acid salts and organic base salts.

In another embodiment of the invention, the conductivity controlling compounds comprises glycols and alcohols that do not effect the resulting coated product.

Further, the vertical orientation of the electrodes and in turn the dielectric plates is of particular importance since with very large areas, there is considerable weight of dielectric material which in turn requires highly accurate positioning relative to an opposing sheet. Non-uniformities in inter-electrode spacing have been shown to significantly affect plasma uniformity and process quality thus mounting the electrodes, vertically overcomes a considerable amount of these problems.

In accordance with the present invention, suitable dielectric materials such as polycarbonate, polyethylene, glass, etc. may be used and the metal electrodes can be of various types and may be bonded to the dielectric material either by adhesive or by some application of heat and fusion of the metal of the electrode to the dielectric material. Similarly, the electrode may be encapsulated within the dielectric material.

In one embodiment of the invention, the dielectric material used was polyethylene and a gap between the boxes of typically 50 to 120 mm was used. The manner of use of process gas in the arrangement can be ideally that described and claimed in our corresponding PCT Patent Publication No. WO 01/59809. It has been found that at low frequency RF plasma excitation frequencies and even with potential differences across the inter-electrode gap of tens of kilovolts, ordinary tap water can be used for cooling provided insulating flexible hoses are used which ensure a water path length between the sparge poles of opposing electrical polarity electrodes of approximately 21 m or more. If the water path length is too short, it becomes difficult or impossible to strike a plasma due to power loss from shorting between electrodes through the cooling water.

It has been found surprisingly that in addition to cooling, the water in accordance with the present invention, also acts to electrically passivate any boundaries, singularities or non-uniformities in the metal electrodes such as edges, corners or mesh ends where wire mesh electrodes are used. It will be appreciated that these, without passivation, can discharge a Corona or other plasma, causing power loss and local heating leading potentially to breakdown. Essentially, the water itself acts as an electrode of limited conductivity to smooth out potential differences and damp out unwanted electrical discharges inside the electrode box. Typically, the plasma generated in the inter-electrode gap will extend about 5 cm beyond the edge of the metal electrode due to water conductivity.

It has been found with the present invention that there are considerable advantages. The particular arrangement allows the plasma path length through which the workpieces pass can be readily extended to any size and to orders of magnitude considerably greater than that of conventional industrial Corona treatment. The residence time in the plasma of the workpiece moving at constant line throughput speed can be readily increased enhancing the target process, whether it is activation, cleaning or coating. Alternatively, for constant residence time, the line speed can be increased. It is also possible to vary and change the plasma power density as is required. Further, there are major advantages in longer residence time in the plasma region that allows the plasma to access all parts of a workpiece surface enhancing uniformity of treatment. This is particularly important with intricately formed workpieces. It has been found with the present invention that it is possible to maintain low electrode temperatures even with high plasma power densities ensuring long equipment lifetimes and elimination of excessive thermal burdens on the workpiece.

One of the great advantages of the vertical electrode arrangement is that there is not the same sag and distortion or deformation that there would otherwise be with horizontally arranged systems. It will also be appreciated that the vertical arrangement allows long plasma path lengths with small factory footprints.

In one embodiment of the invention, an array of three double-sided electrodes and two single-sided electrodes was constructed to create a set of four plasma paths side-by-side of the general configuration shown in FIG. 8. There were essentially eight sets of opposing metal electrodes where each metal electrode measured 2100 mm wide by 400 mm long to give a total plasma path length of 3.2 meters and a web width processing capability of 2.1 meters. Using rollers above and below the plasma assemblies, webs were directed through the entire plasma region. FIGS. 9 and 10 show alternative arrangements.

Precursor process gases such as Helium, Oxygen, Argon, Nitrogen, Halocarbons, silicon tetrachloride, siloxanes, etc. were used. Radio Frequency power was applied using a power supply to the electrodes via matching transformers at approximately 40 kHz and about 30 kW of RF power. The system was operated for more than 1000 hours without failure.

In the specification the terms “comprise, comprises, comprised and comprising” or any variation thereof and the terms “include, includes, included and including” or any variation thereof are considered to be totally interchangeable and they should all be afforded the widest possible interpretation.

The invention is not limited to the embodiments hereinbefore described but may be varied in both construction and detail.

What is claimed is:

1. An atmospheric pressure plasma assembly of the type comprising a pair of parallel spaced-apart planar electrodes with at least one dielectric plate therebetween and adjacent one electrode, the spacing between the dielectric plate and the other dielectric plate or electrode forming a plasma region for a precursor gas characterized, in that, when an electrode is adjacent a dielectric plate, a cooling liquid distribution system is provided for directing a cooling conductive liquid onto the exterior of the electrode to cover a planar face of the electrode.

2. An assembly as claimed in claim 1, in which the cooling liquid covers the face of the electrode remote from the dielectric plate.

3. An assembly as claimed in claim 1, in which the cooling conductive liquid is water.

4. An assembly as claimed in claim 3, in which the water contains conductivity controlling compounds.

5. An assembly as claimed in claim 4, in which the conductivity controlling compounds are metal salts.

6. An assembly as claimed in claim 4, in which the conductivity controlling compounds are soluble organic additives.

7. An assembly as claimed in claim 1, in which the electrode is a metal electrode in contact with the dielectric plate.

8. An assembly as claimed in claim 1, in which there are a pair of metal electrodes each in contact with a dielectric plate.

9. An assembly as claimed in claim 1, in which the dielectric plate extends beyond the perimeter of the electrode and the cooling liquid is also directed across the dielectric plate to cover at l ast that portion of dielectric bordering the periphery of the electrode.

10. An assembly as claimed in claim 9, in which all of the dielectric plate is covered with cooling liquid.

11. An assembly as claimed in claim 1, in which the electrode is in the form of a metal mesh.

12. An assembly as claimed in claim 1, in which the electrodes are arranged substantially vertically for reception of a work piece therebetween.

13. An assembly as claimed in claim 12, in which insulated spacers are mounted between th electrodes.

14. An assembly as claimed in claim 1, in which the electrode forms part of an electrode assembly comprising a watertight box having a side formed by a dielectric plate having bonded thereto on the interior of the box the planar electrode a liquid inlet and a liquid outlet.

15. An assembly as claimed in claim 1, in which the electrode forms part of an electrode assembly comprising a watertight box having two parallel sides each formed from a dielectric plate end each having bonded thereto on the interior of the box one of a a pair of planar electrodes, a liquid inlet and a liquid outlet.

16. An assembly comprising two boxes as claimed in claim 14.

17. An assembly comprising two boxes as claimed in claim 14 and one or more of the boxes as claimed in claim 15 mounted therebetween.

18. An assembly as claimed in claim 14, in which the boxes are one on top of the other to provide an extended plasma region.

19. An assembly as claimed in claim 1, in which the liquid distribution system comprises a cooler and a recirculation pump.

20. An assembly as claimed in claim 1, in which the cooling liquid distribution system comprises a sparge pipe incorporating spray nozzles.

21. A method of treating a substrate using an assembly as claimed in claim 1.

22. A substrate treated in accordance with a method of claim 21.
